(19) United States
(12) Patent Application Publication
(10) Pub. No.: US 2012/0276777 A1
(43) Pub. Date: Nov. 1, 2012

(54) Plug Connector and Connector Assembly

(76) Inventors: Biaobing Lv, Shanghai (CN); Huibin Li, Shanghai (CN); Wei Yao, Shanghai (CN)

(21) Appl. No.: 13/458,331

(22) Filed: Apr. 27, 2012

(30) Foreign Application Priority Data
Apr. 29, 2011 (CN) 201120138926.9

(51) Int. Cl. H01R 24/00; H01R 13/648

(52) U.S. Cl. 439/607.01; 439/660

(57) ABSTRACT

A plug includes an insulation body, a plurality of first contacts, and a plurality of second contacts. The plurality of first contacts are assembled in the insulation body and include a plurality of first contact portions disposed at a first side of the insulation body and a plurality of first legs disposed along a second side of the insulation body. The plurality of first contact portions are arranged in a first row along the first side. The plurality of second contacts are assembled in the insulation body and include a plurality of second contact portions disposed at the first side of the insulation body and a plurality of second legs disposed along the second side. The plurality of second contact portions are arranged along a second row along the surface side of the first side such that the first row is spaced from the second row by a predetermined distance.

### CROSS-REFERENCE TO RELATED APPLICATION

This application claims priority under 35 U.S.C. §119 to Chinese Patent Application No. 201120138926.9 filed on Apr. 29, 2011.

### FIELD OF THE INVENTION

The present invention relates to a connector assembly and, more particularly, to a plug and a receptacle mated with the plug.

### BACKGROUND

A connector is known that is adapted to transmit only one respective kind of signals, for example, the conventional Micro USB (Universal Serial Bus) connector is adapted to transmit only Micro USB signals, and the conventional MHL (Mobile High-Definition Link) connector is adapted to transmit only MHL signals.

Accordingly, in the prior art, when it needs to simultaneously transmit two different kinds of signals, two respective kinds of connectors for transmitting the two different kinds of signals have to be used in an electronic apparatus, such as a notebook Personal Computer, a mobile communication device, etc. Such two kinds of connectors increase the size and cost of the electronic apparatus, and it is very inconvenient for a user to use the electronic apparatus.

### SUMMARY

The invention has been made to overcome or alleviate at least one aspect of the above mentioned disadvantages. Accordingly, it is desirable to provide a compact connector that is able to simultaneously transmit two different kinds of signals without increasing the size and cost of it.

The connector includes a plug having an insulation body, a plurality of first contacts, and a plurality of second contacts. The plurality of first contacts are assembled in the insulation body and include a plurality of first contact portions disposed at a first side of the insulation body and a plurality of first legs disposed along a second side of the insulation body. The plurality of first contact portions are arranged in a first row along the first side. The plurality of second contacts are assembled in the insulation body and include a plurality of second contact portions disposed at the first side of the insulation body and a plurality of second legs disposed along the second side. The plurality of second contact portions are arranged along a second row along the surface side of the first side such that the first row is spaced from the second row by a predetermined distance.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view showing an insulation body of a receptacle according to the invention;

FIG. 2 is a perspective view showing a metal shield detached from the insulation body of the receptacle according to the invention;

FIG. 3 is a perspective view of the metal shield;

FIG. 4 is a perspective view of an insulation body of a plug according to the invention;

FIG. 5 is a bottom perspective view of the insulation body shown in FIG. 4;

FIG. 6 is a perspective view of the plug with a metal shield detached from the insulation body;

FIG. 7 is a perspective view of the plug after the metal shield has been assembled on the insulation body of the plug; and

FIG. 8 is another perspective view of the plug and assembled metal shield as shown in FIG. 7.

### DETAILED DESCRIPTION OF THE EMBODIMENT(S)

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

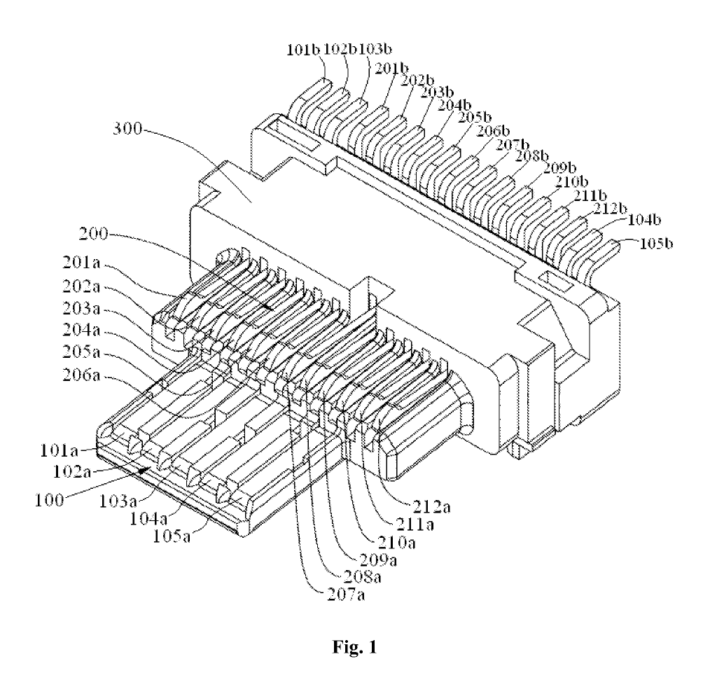

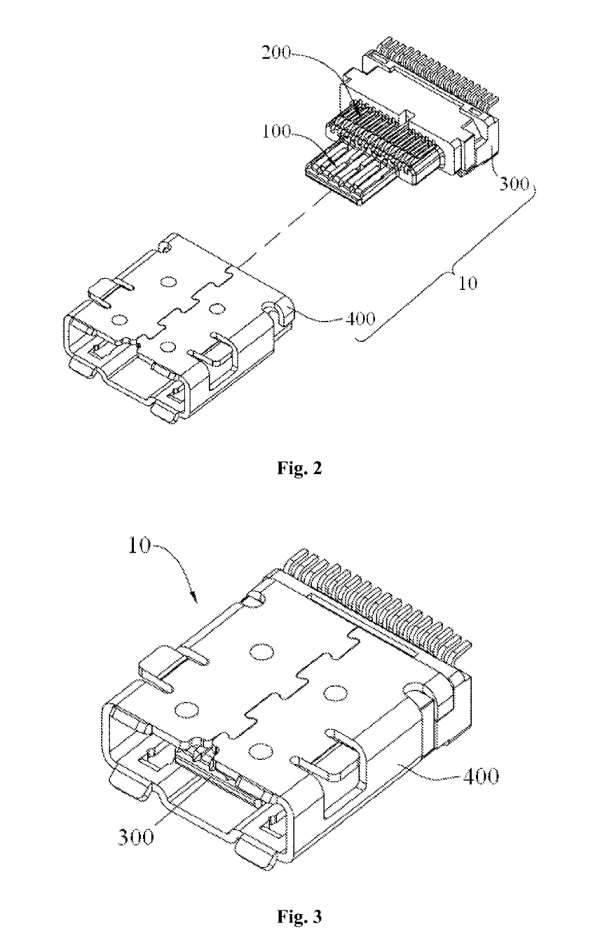

As shown in FIGS. 1-3, a receptacle 10 includes an insulation body 300, a plurality of first contacts 100, a plurality of second contacts 200, and a metal shield 400. The plurality of first contacts 100 and the plurality of second contacts 200 are assembled in the insulation body 300. The insulation body 300 is received in the metal shield 400.

With reference to FIG. 1, the plurality of first contacts 100 may be a plurality of Micro-USB contacts consisting of five contacts for transmitting Micro-USB signals. In the exemplary embodiment shown in FIG. 1, the plurality of first contacts 100 has a plurality of first contact portions 101a, 102a, 103a, 104a and 105a at one side of the insulation body 300 and a plurality of first legs 101b, 102b, 103b, 104b and 105b along the other side of the insulation body 300.

Referring to FIG. 1 again, the plurality of second contacts 200 may be a plurality of I/O contacts consisting of twelve contacts for transmitting MHL signals. In the exemplary embodiment shown in FIG. 1, the plurality of second contacts 200 has a plurality of second contact portions 201a, 202a, 203a, 204a, 205a, 206a, 207a, 208a, 209a, 210a, 211a and 212a at the one side of the insulation body 300 and a plurality of second legs 201b, 202b, 203b, 204b, 205b, 206b, 207b, 208b, 209b, 210b, 21 lb and 212b along the other side of the insulation body 300.

As shown in FIG. 1, the plurality of first contact portions 101a, 102a, 103a, 104a, 105a are arranged in one row in a lateral direction of the insulation body 300. The plurality of second contact portions 201a, 202a, 203a, 204a, 205a, 206a, 207a, 208a, 209a, 210a, 211a and 212a are arranged in another row in the lateral direction of the insulation body 300.

The row of first contact portions 101a, 102a, 103a, 104a and 105a is spaced from the row of second contact portions 201a, 202a, 203a, 204a, 205a, 206a, 207a, 208a, 209a, 210a, 211a and 212a by a predetermined distance in a longitudinal direction of the insulation body 300. Please be noted that, for more clearly describing the receptacle 10, a length direction of the first and second contacts is defined as the longitudinal direction of the insulation body 300, and a width direction of the first and second contacts is defined as the lateral direction of the insulation body 300.

As shown in FIG. 1, the row of first contact portions 101a, 102a, 103a, 104a and 105a is located in front of the row of second contact portions 201a, 202a, 203a, 204a, 205a, 206a, 207a, 208a, 209a, 210a, 211a and 212a, along a longitudinal direction of the insulation body 300.

As shown in FIG. 1, the row of first contact portions 101a, 102a, 103a, 104a and 105a is spaced from the row of second contact portions 201a, 202a, 203a, 204a, 205a, 206a, 207a, 208a, 209a, 210a, 211a and 212a by a height with respect to a thickness of the insulation body 300. That is, the row of first contact portions and the row of second contact portions are positioned at two different height locations, respectively. However, the invention is not limited to this disclosure, and the row of first contact portions and the row of second contact portions may be positioned at a same height location in other embodiments according to the invention.

As shown in FIG. 1, the plurality of first legs 101b, 102b, 103b, 104b and 105b and the plurality of second legs 201b, 202b, 203b, 204b, 205b, 206b, 207b, 208b, 209b, 210b, 211b and 212b are arranged in one row along the other side of the insulation body 300. In this way, the plurality of first legs and the plurality of second legs may be easily soldered on a PCB (not shown) in a manner of SMT (Surface Mounted Technology).

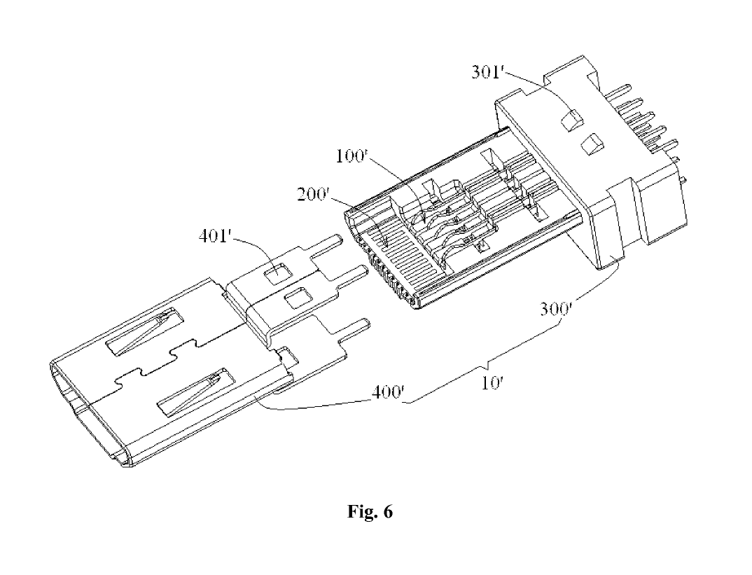

As shown in FIG. 6, a plug 10′ includes an insulation body 300′, a plurality of first contacts 100′, a plurality of second contacts 200′, and a metal shield 400′. The plurality of first contacts 100′ and the plurality of second contacts 200′ are assembled in the insulation body 300′. The insulation body 300′ is received in the metal shield 400′.

With reference to FIG. 6, the metal shield 400′ may be assembled on the insulation body 300′ in a snap-fit manner. For example, as shown in FIG. 6, the insulation body 300′ is formed with protrusions 301′ thereon, and the metal shield 400′ is formed with slots 401′ which mate with the protrusions 301′. In this way, the metal shield 400′ and the insulation body 300′ may be assembled together by the protrusions 301′ and the slots 401′ in the snap-fit manner.

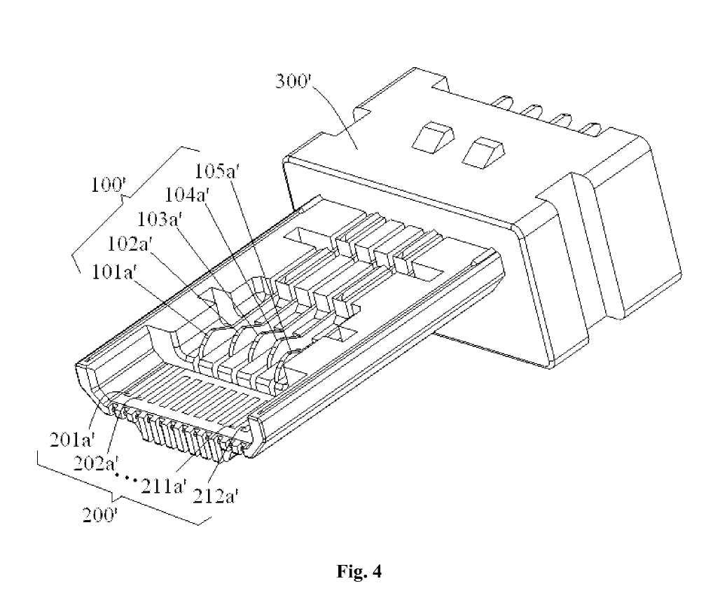

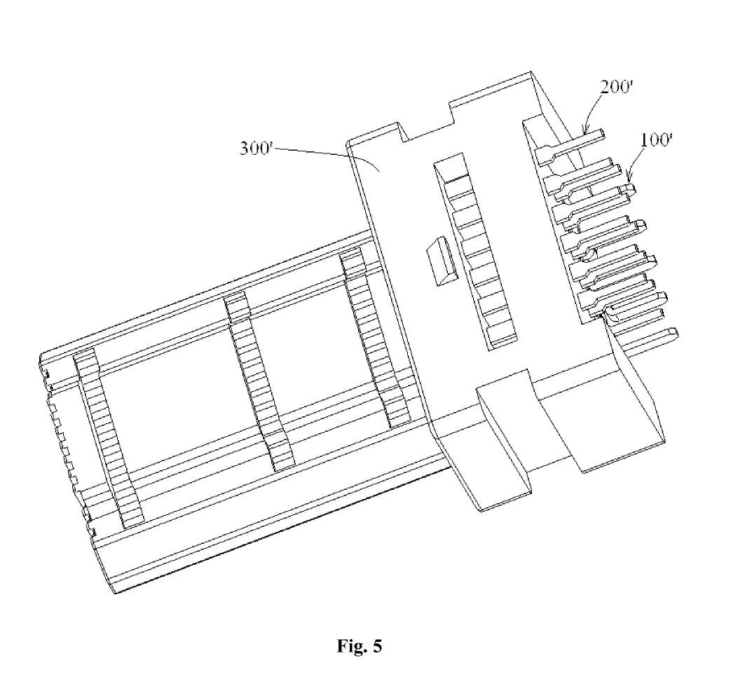

As shown in FIGS. 4-5, the plurality of first contacts 100′ may be a plurality of Micro-USB contacts consisting of five contacts for transmitting Micro-USB signals. In the exemplary embodiment shown in FIGS. 4-5, the plurality of first contacts 100′ has a plurality of first contact portions 101a′, 102a′, 103a′, 104a′ and 105a′ at one side of the insulation body 300′.

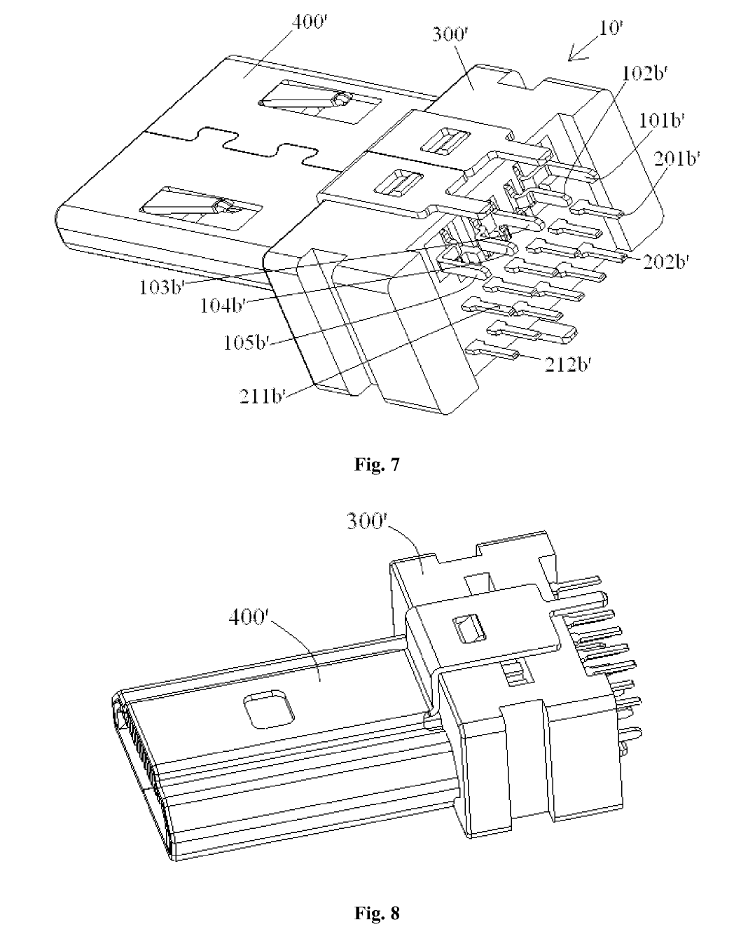

As shown in FIGS. 7-8, in an exemplary embodiment, the plurality of first contacts 100′ further has a plurality of first legs 101b′, 102b′, 103b′, 104b′ and 105b′ along the other side of the insulation body 300′.

Referring back to FIGS. 4-5 again, the plurality of second contacts 200′ may be a plurality of I/O contacts consisting of twelve contacts for transmitting MHL signals. In the exemplary embodiment shown in FIGS. 4-5, the plurality of second contacts 200′ include a plurality of second contact portions 201a′, 202a′, 203a′, 204a′, 205a′, 206a′, 207a′, 208a′, 209a′, 210a′, 211a′ and 212a′ at the one side of the insulation body 300′.

As shown in FIGS. 7-8, the plurality of second contacts 200′ further has a plurality of second legs 201b′, 202b′, 203a′, 204a′, 205a′, 206a′, 207a′, 208a′, 209a′, 210a′, 211b′ and 212b′ along the other side of the insulation body 300′.

Please refer to FIG. 4, in the exemplary embodiment, the plurality of first contact portions 101a′, 102a′, 103a′, 104a′ and 105a′ are arranged in one row along a lateral direction of the insulation body 300′. The plurality of second contact portions 201a′, 202a′, 203a′, 204a′, 205a′, 206a′, 207a′, 208a′, 209a′, 210a′, 211a′ and 212a′ are arranged in another row along the lateral direction of the insulation body 300′.

As shown in FIG. 4, the row of first contact portions 101a′, 102a′, 103a′, 104a′ and 105a′ is spaced from the row of second contact portions 201a′, 202a′, 203a′, 204a′, 205a′, 206a′, 207a′, 208a′, 209a′, 210a′, 211a′ and 212a′ by a predetermined distance along a longitudinal direction of the insulation body 300′. Please be noted that, for more clearly describing the plug 10′ of the present invention, a length direction of the first and second contacts 100′, 200′ is defined as the longitudinal direction of the insulation body 300′, and a width direction of the first and second contacts 100′, 200′ is defined as the lateral direction of the insulation body 300′.

As shown in the exemplary embodiment of FIG. 4, the row of first contact portions 101a′, 102a′, 103a′, 104a′ and 105a′ is located behind the row of second contact portions 201a′, 202a′, 203a′, 204a′, 205a′, 206a′, 207a′, 208a′, 209a′, 210a′, 211a′ and 212a′, with respect to the longitudinal direction of the insulation body 300′.

In an exemplary embodiment, as shown in FIG. 4, the row of first contact portions 101a′, 102a′, 103a′, 104a′ and 105a′ is spaced from the row of second contact portions 201a′, 202a′, 203a′, 204a′, 205a′, 206a′, 207a′, 208a′, 209a′, 210a′, 211a′, 212a′ by a height with respect to a thickness of the insulation body 300′. That is, the row of first contact portions and the row of second contact portions are positioned at two different height locations, respectively. But, the invention is not limited to the shown disclosure. Rather, the row of first contact portions and the row of second contact portions may be positioned at a same height location.

As shown in FIG. 7, the plurality of first legs 101b′, 102b′, 103b′, 104b′ and 105b′ are arranged in one row in the lateral direction of the insulation body 300′. The plurality of second legs 201b′, 202b′, 203b′, 204b′, 205b′, 206b′, 207b′, 208b′, 209b′, 210b′, 211b′ and 212b′ are arranged in two rows in the lateral direction of the insulation body 300′. The one row of first legs and the two rows of second legs are spaced from each other by a height with respect to a thickness of the insulation body 300′. That is, the one row of first legs and the two rows of second legs are positioned at three different height locations, respectively.

In the shown embodiment in FIGS. 4 through 8, the plug 10′ may be mated with the receptacle 10 shown in FIGS. 1-3 to form a connector assembly.

Although not shown, when the plug 10′ is inserted into the receptacle 10, the plurality of first contact portions 101a′, 102a′, 103a′, 104a′ and 105a′ and the plurality of second contact portions 201a′, 202a′, 203a′, 204a′, 205a′, 206a′, 207a′, 208a′, 209a′, 210a′, 211a′, 212a′ of the plug 10′ electrically contact with the plurality of first contact portions 101a, 102a, 103a, 104a and 105a and a plurality of second contact portions 201a, 202a, 203a, 204a, 205a, 206a, 207a, 208a, 209a, 210a, 211a and 212a of the receptacle 10, respectively.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A plug, comprising:
an insulation body;
a plurality of first contacts assembled in the insulation body and having a plurality of first contact portions disposed at a first side of the insulation body and a plurality of first legs disposed along a second side of the insulation body, the plurality of first contact portions arranged in a first row along a surface side of the first side; and
a plurality of second contacts assembled in the insulation body and having a plurality of second contact portions disposed at the first side of the insulation body and a plurality of second legs disposed along the second side of the insulation body, the plurality of second contact portions arranged along a second row along the surface side of the first side such that the first row is spaced from the second row by a predetermined distance along a longitudinal axis of the insulation body.

2. The plug according to claim 1, further comprising a metal shield covering the insulation body.

3. The plug according to claim 2, wherein the metal shield receives the insulation body and connects in a snap-fit manner.

4. The plug according to claim 3, wherein the insulation body includes a protrusion and the metal shield includes a slot which receives the protrusion.

5. The plug according to claim 1, wherein the first row is spaced from the second row by a height with respect to a thickness of the insulation body.

6. The plug according to claim 1, wherein the plurality of first legs are arranged along a third row along the second side.

7. The plug according to claim 6, wherein the plurality of second legs are arranged along a plurality of fourth rows along the second side.

8. The plug according to claim 7, wherein one of the plurality of fourth rows are spaced from the third row by a height with respect to a thickness of the insulation body.

9. The plug according to claim 1, wherein the plurality of first contacts is a plurality of Micro USB contacts consisting of five contacts.

10. The plug according to claim 9, wherein the plurality of second contacts is a plurality of I/O contacts consisting of twelve contacts.

11. The plug according to claim 1, wherein the plurality of second contacts is a plurality of I/O contacts consisting of twelve contacts.

12. A connector assembly, comprising:
a receptacle having;
a receptacle insulation body;
a plurality of first receptacle contacts assembled in the receptacle insulation body and having a plurality of first receptacle contact portions disposed at a first side of the receptacle insulation body and a plurality of first receptacle legs disposed along a second side of the receptacle insulation body, the plurality of first receptacle contact portions arranged in a first receptacle row along a surface side of the first side; and
a plurality of second receptacle contacts assembled in the receptacle insulation body and having a plurality of second receptacle contact portions disposed at the first side of the receptacle insulation body and a plurality of second receptacle legs disposed along the second side of the receptacle insulation body, the plurality of second receptacle contact portions arranged along a second receptacle row along the surface side of the first side such that the first receptacle row is spaced from the second receptacle row by a predetermined distance along a longitudinal axis of the receptacle insulation body; and
a plug, having:
a plug insulation body;
a plurality of first plug contacts assembled in the plug insulation body and having a plurality of first plug contact portions disposed at a first side of the plug insulation body and a plurality of first plug legs disposed along a second side of the plug insulation body, the plurality of first plug contact portions arranged in a first plug row along a surface side of the first side; and
a plurality of second plug contacts assembled in the plug insulation body and having a plurality of second plug contact portions disposed at the first side of the plug insulation body and a plurality of second plug legs disposed along the second side of the plug insulation body, the plurality of second plug contact portions arranged along a second plug row along the surface side of the first side such that the first plug row is spaced from the second plug row by a predetermined distance along a longitudinal axis of the plug insulation body.

13. The connector assembly according to claim 12, wherein the plurality of first receptacle legs and the plurality of second receptacle legs are arranged along a third receptacle row along the second side of the receptacle insulation body.

14. The connector assembly according to claim 13, wherein the first plug row is spaced from the second plug row by a height with respect to a thickness of insulation body.

15. The connector assembly according to claim 14, wherein the plurality of first plug legs are arranged along a third plug row along the second side of the plug insulation body.

16. The connector assembly according to claim 15, wherein the plurality of second plug legs are arranged along the third plug row.

17. The connector assembly according to claim 16, wherein the plurality of second plug legs are arranged along a plurality of fourth plug rows positioned along the second side of the plug insulation body.

18. The connector assembly according to claim 17, wherein one of the plurality of fourth plug rows are spaced from third plug row by a height with respect to the thickness.
